(19) United States
(12) Patent Application Publication
(10) Pub. No.: US 2012/0237762 A1
(43) Pub. Date: Sep. 20, 2012

(54) DEVICE CONSTRUCTS AND METHODS OF COATING LUMINESCENT PHOSPHORS FOR DISPLAY AND LIGHTING APPLICATIONS

(75) Inventors: Charles E. Hunt, Davis, CA (US); Helmut Baumgart, Yorktown, VA (US); Diefeng Gu, Yorktown, VA (US)

(73) Assignees: OLD DOMINION UNIVERSITY RESEARCH FOUNDATION, Norfolk, VA (US); THE REGENTS OF THE UNIVERSITY OF CALIFORNIA, Oakland, CA (US)

(21) Appl. No.: 13/423,216

(22) Filed: Mar. 17, 2012

Related U.S. Application Data
(60) Provisional application No. 61/454,303, filed on Mar. 18, 2011.

(51) Int. Cl. B32B 17/06; B05D 5/12; B05D 5/06

(52) U.S. Cl. 428/332; 428/690; 428/432; 428/446; 427/67

(57) ABSTRACT

A device construct for lighting and display applications is fabricated from a substrate, a deposited phosphor layer over the substrate, and a layer of thermal and electrically-conductive luminescent material over the deposited layer. The layer of thermal and electrically-conductive luminescent material is a thin film that conforms to the morphology of the phosphor layer. The device is fabricated by providing a substrate, depositing a thin layer of phosphor powder on the substrate by any technique, and coating the phosphor layer with a layer of thermal and electrically-conductive luminescent material by atomic layer deposition.

### CROSS-REFERENCE TO RELATED APPLICATIONS

This application claims priority from U.S. provisional patent application Ser. No. 61/454,303 filed on Mar. 18, 2011, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains to luminescent phosphors used for lighting and display applications.

2. Description of Related Art

Luminescent phosphors used for lighting and display applications are typically ceramic or other insulator, or poorly conductive semiconductors particles (0.5 um-25 um in average diameter). It is common practice to coat the particles to (1) improve the electrical and/or thermal conductivity, (2) passivate the particle surface in a manner which reduces the amount of non-luminescent “dead-space” material at the surface, and (3) improve the surface conditions in a manner which enables adhesion to a substrate, such as the glass envelope of a lamp, or the faceplate of a display. Current practice is to coat the particles (by various means) and then deposit the particles onto the substrate, also by various means. The standard practice deposition method typically requires a “binder”, such as non-luminescent silicates, to make adherence to the substrate possible.

Current methods, for example, include coating ZnO or Indium Oxide directly on the particles before deposition of the layer. This requires the use of a non-luminescent binder, which degrades efficacy, thermal stability, and lifetime of the phosphors. Indium Oxide is a limited resource (indium). Current standard practice phosphor deposition methods (see, for example, K. Y. Sasaki, et al., Advanced Materials, vol 11, p. 91, 1999, incorporated herein by reference) are more complicated, do not dissipate heat sufficiently, with a resultant loss in phosphor efficacy, phosphor overheating, and degraded phosphor lifetime.

Alternative methods include the use of Carbon Nanotubes (CNT) (J. H. Park et al., Electrochem. Sol. State Let. 11 J12 (2008), incorporated herein by reference), which also require a binder, and require a differing deposition method of the phosphor layer because of the hydrophobicity of the CNT. The black CNT also degrades luminous efficacy of the phosphors to some extent because of its heavy photon absorbtion.

Trichromatic RGB mixtures of phosphors for white light, either for cathodoluminescent (CL) applications such as BLU or ESL, or for photoluminescent (PL) applications, such as compact fluorescent (CFL) or near-UV LED, typically use a red component of Y₂O₃:Eu or Y₂O₂S:Eu, depending on the degree of saturation desired. Although these compounds represent the best red phosphors available, they suffer from diminishing efficacy and lifetime with increasing power density. The severe loss in efficacy is resultant of the poor thermal and electrical conductivity (in CL use) of Y₂O₃:Eu particles. The situation is worsened in that most white-light applications need to be operated at power densities exceeding 150 mW/cm². Moreover, phosphor screens often employ silicate binders for adherence to the glass lamp, further diminishing thermal conductivity. Some investigations have attempted to mitigate this by coating the phosphors with carbon nanotubes, however, the black nanotubes are non-luminescent and results are insufficient at higher power densities. CNT, being hydrophobic, also complicates the deposition process.

### SUMMARY OF THE INVENTION

Our invention is a new way of coating luminescent phosphors used for lighting and display applications. In one embodiment, our invention entails the deposition of the uncoated phosphor particles onto the substrate, followed by subsequent coating, in-situ, with nano-scale ZnO using Atomic Layer Deposition (ALD). This approach accomplishes several important functions simultaneously. First, it allows adhesion of the luminescent phosphors onto the substrate without the use of non-luminescent binders. The elimination of silicate (or other) binders allows for an increase in luminous efficacy (efficiency) of the phosphor, as well as elimination of a thermal insulator from the process. Second, the nanoscale coating of ZnO binds the phosphor onto the substrate. ZnO is a good thermal conductor. Third, the very thin layer of ZnO does not degrade the luminous efficacy of the luminescent phosphor particles being coated. Fourth, the electrical conductivity of the ZnO is sufficient to provide a conductive path of electrons away from the phosphor, during operation, and thereby prevent charging of the particle. The subsequent result is an improvement of efficacy of the phosphor particle, as well as the entire luminescent phosphor layer on the substrate. Fifth, the good thermal conductivity of the ZnO coating helps dissipate heat from the phosphor layer. The consequence of this process is improved efficacy and lifetime of the phosphor layer through the resultant lower-temperature operation. Sixth, the luminous properties of the nano-scale ZnO coating passivates the surface states of the phosphor, potentially improving the efficacy of the phosphor. Seventh, interception by the ZnO coating of energy (photons or electrons used to excite the phosphor particles), if it happens, results in a luminescent process within the ZnO itself, since it is both a photoluminescent as well as cathodoluminescent material.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 schematically illustrates a device construct according to an embodiment of the invention.

FIG. 2 is a flowchart showing a fabrication method according to an embodiment of the present invention.

FIG. 3 is a graph of the ALD ZnO process window according to an embodiment of the present invention based on deposition rate vs. temperature.

FIG. 4 is an image of loosely packed Y₂O₃:Eu²⁺ particles deposited by sedimentation.

FIG. 5 is an SEM image with higher magnification of Y₂O₃:Eu²⁺ particles coated with 100 nm of ALD ZnO film.

FIG. 6 compares conductance of ALD ZnO vs. ALD cycle. ZnO conductivity increases as the coating thickness is increased.

FIG. 7 is a photoluminescence study of Y₂O₃:Eu²⁺ and Y₂O₃:Eu²⁺ coated with ZnO.

### DESCRIPTION OF THE INVENTION

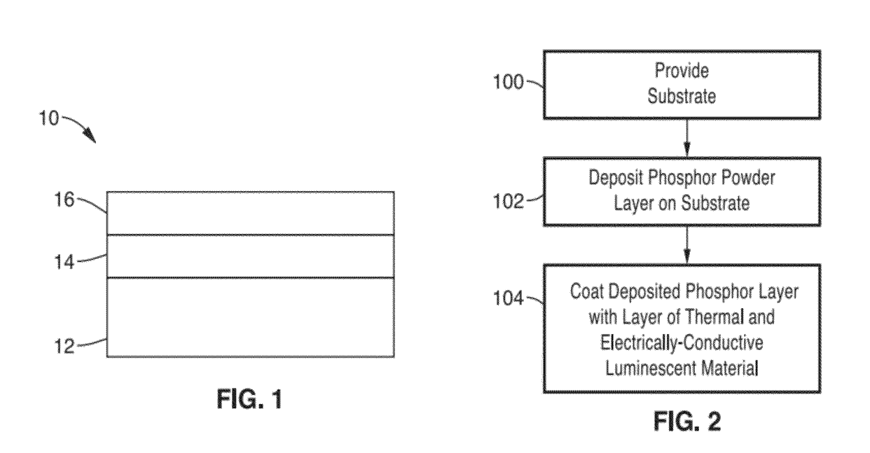

Referring to FIG. 1, a device construct 10 according to an embodiment of the present invention comprises a substrate 12, a phosphor powder layer 14 deposited over the substrate, and a layer of thermal and electrically-conductive luminescent material 16 deposited over the phosphor powder layer as a coating.

The substrate can, for example, be a substrate selected from the group of media consisting of glass, quartz, fused silica, borosilicate, and other transparent media. The phosphor can, for example, be a phosphor selected from the group of phosphors consisting not only of Y₂O₃:Eu, Y₂O₂S:Eu, but any cathodoluminescent (CL) phosphor orphotoluminescent (PL) phosphor.

In one embodiment, the layer of thermal and electrically-conductive luminescent material comprises a thin film that conforms to the morphology of the phosphor powder layer. Preferably, the layer of thermal and electrically-conductive luminescent material has a uniform thickness, and the thickness can range up to approximately 100 nm.

In the discussion that follows, we describe using ZnO as the thermal and electrically-conductive luminescent material. We also describe depositing the phosphor powder using the sedimentation technique, and depositing the electrically-conductive luminescent material using the atomic layer deposition (ALD) method. However, from the discussion herein, those skilled in the art will appreciate that the ALD coating works for any deposition method of phosphors, and also that In₂O₃ or any other thermal and electrically-conductive luminescent material which might be deposited by the ALD method could be used instead of ZnO.

Referring now to FIG. 2, in a preferred embodiment the device construct is fabricated by providing a substrate at step 100, depositing the phosphor powder layer on the substrate at step 102, and then coating the deposited phosphor layer with ZnO layer by atomic layer deposition (ALD) at step 104. The ALD coating step transfers heat and charge, and simultaneously serves as the binding, thereby eliminating the use of non-luminescent silicate binders. The ZnO layer can, for example, be deposited using diethyl Zinc and H₂O vapor, preferably at approximately 80° C. to approximately 200° C. and more preferably at approximately 150° C. In the case of approximately 150° C., the ZnO layer is deposited using a film deposition rate of approximately 2 Å/cycle. Other precursors can be used as well, and the deposition rate would depend on the specific precursor and temperate.

### EXAMPLE 1

We present here a first demonstration of coating of Y₂O₃:Eu red phosphor powder with ZnO by ALD. ALD provides unique features such as precise thickness control of ZnO thin films with atomic resolution, high uniformity and absolute conformity. ALD is capable of coating complex surface morphologies and penetrating minute voids.

A thin layer of red phosphor powder was deposited on a Si substrate by the sedimentation technique and coated with a thin film of ALD ZnO. We used a Savannah s100 from Cambridge Nanotech for deposition. The substrate was a 4-inch P-type Si (100) wafer. The ALD ZnO coatings were deposited using diethyl Zinc and H₂O vapor at 150° C. The carrier gas was N₂. The film deposition rate was approximately 2 Å/cycle. Approximately four hundred ALD cycles resulted in an approximately 80 nm ZnO luminescent conductive coating.

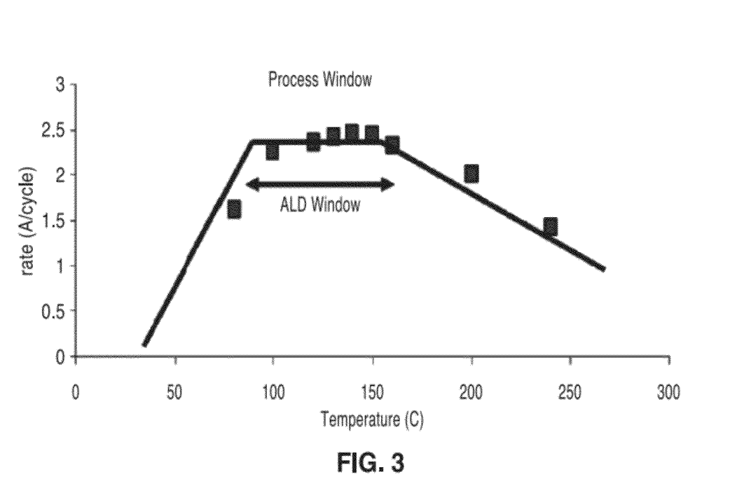

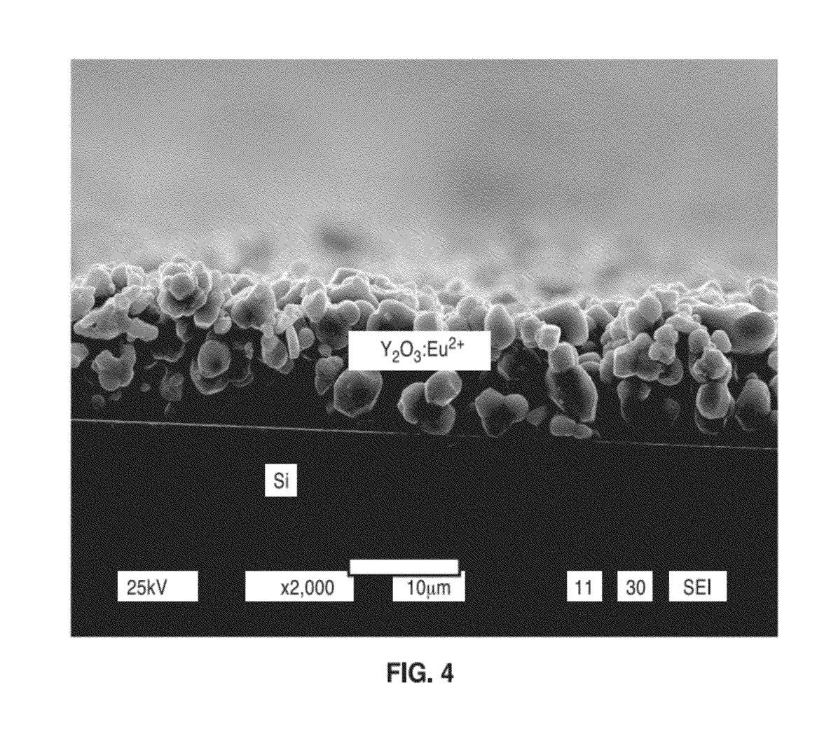

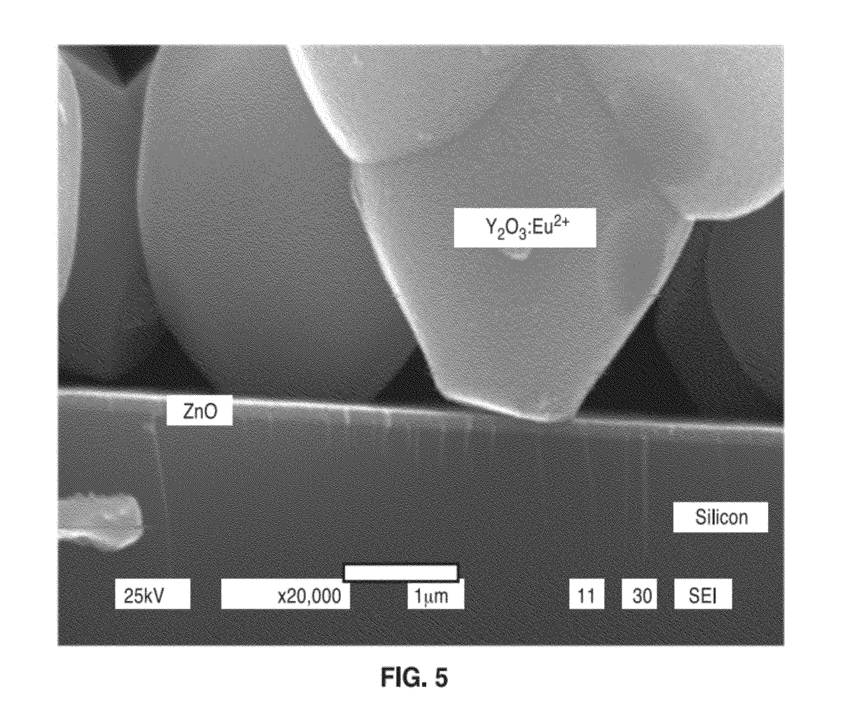

FIG. 3 shows the ALD ZnO process window for a film deposition rate in the ALD process of approximately 2 Å/cycle. The film thicknesses were measured using spectroscopic ellipsometry. FIG. 4 is an SEM image of loosely packed red phosphor particles and FIG. 5 shows that every single red phosphor particle was coated with 100 nm ZnO including the Si substrate. It is important to note that, in our coating process, we do not specifically coat the powder particles individually as others have done, Instead, we coat the sedimentary layer (settled powder layer), which is a technique that has not been previously reported. When we coat the sedimentary layer with ZnO in this manner, the exposed surfaces of the phosphor particles are coated with a thin layer of ZnO that also bridges the gaps between the particles, thus establishing a thin film over the sedimentary layer that conforms to the morphology of the sedimentary layer as can be seen in FIG. 4 and FIG. 5.

### EXAMPLE 2

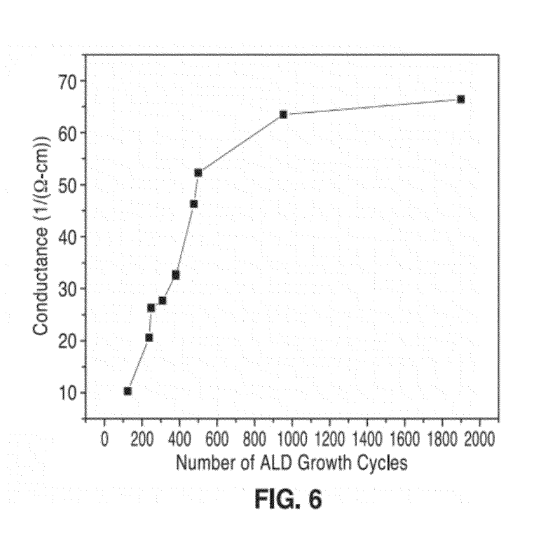

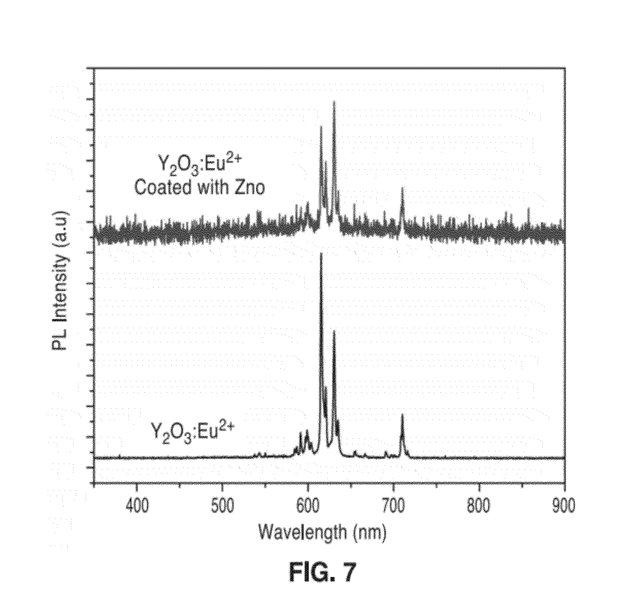

FIG. 6 shows the electrical conductivity of the ALD ZnO films. After coating the red phosphor, the four-point probe measurements revealed very low resistivity (˜0.02Ω-cm) for the as-deposited 100 nm ALD ZnO thin films. The photoluminescence study revealed a bright red emission of Y₂O₃:Eu²⁺. After coating with ALD ZnO, our measurements show that the red emission of Y₂O₃:Eu²⁺ is conserved, as shown in FIG. 7. The results demonstrate that not only can the silicate binder be replaced with luminescent ZnO, but thermal and electrical conductivity can be enhanced, in order to improve efficacy, lifetime, and thermal stability, by the same process.

To summarize, we are binding the particles, as well as coating them, using ALD, thus eliminating non-luminescent binding materials, such as silicates. Compared to current approaches, this process is simplified, and improved in thermal and electrical conductivity, as well as using a thin, luminescent material as the binder.

While we used a Si substrate for fabrication of the device construct, it will be appreciated that for lighting and display applications a transparent substrate such as glass, quartz, fused silica, borosilicate, and other transparent media would be used. Also, our technique is not limited to coating red phosphor and can be used for all other phosphor colors as well. Additionally, our technique can be used for CL or PL phosphor types.

We have thus described a construct for lighting and display applications that comprises a substrate, a deposited phosphor layer over the substrate, and a ZnO layer over the deposited layer. The ZnO layer is a thin film that conforms to the morphology of the phosphor layer. We have also described a fabrication method that comprises providing a substrate, depositing a thin layer of phosphor powder on the substrate by sedimentation technique, and coating the phosphor layer with ZnO by ALD. Our construct can readily be incorporated as a component in a light emission apparatus such as an energy-efficient ESL lamp that uses CL phosphors, field-emission cathode electron lamps, and photocathode electron lamps. Our device construct is applicable to CFL, LED, and ESL lighting types, potentially improving efficacy and lifetime.

We have demonstrated that (i) ALD ZnO coating of Y₂O₃:Eu²⁺ Red Phosphor results in high-quality, uniform nano-scale layer; (ii) approximately four hundred 400 ALD cycles results in an approximately 80 nm ZnO luminescent, conductive coating; (iii) a ZnO coating used on (sedimentary-deposit) film effectively replaces non-luminescent binders; and (iv) ZnO demonstrates superior thermal and electrical conductivity over silicate binders.

From the discussion herein it will be appreciated that our invention includes various aspects and embodiments, such as, but not limited to, the following:

1. A device construct, comprising: a substrate; a phosphor powder layer over the substrate; and a layer of thermal and electrically-conductive luminescent material over the powder layer.

2. The device construct of embodiment 1, wherein the phosphor comprises a deposited phosphor layer.

3. The device construct of embodiment 1, wherein the substrate is selected from the group of media consisting of glass, quartz, fused silica, borosilicate, and other transparent media.

4. The device construct of embodiment 1, wherein the phosphor is selected from the group of phosphors consisting of Y₂O₃:Eu, Y₂O₂S:Eu, or any cathodoluminescent (CL) phosphors or photoluminescent (PL) phosphors.

5. The device construct of embodiment 1, wherein the layer of thermal and electrically-conductive luminescent material comprises a thin film that conforms to the morphology of the phosphor powder layer.

6. The device construct of embodiment 1, wherein the layer of thermal and electrically-conductive luminescent material has a uniform thickness of up to approximately 100 nm.

7. The device construct of embodiment 1, wherein the device construct is a component of a light emission apparatus.

8. A method of fabricating a device construct, comprising: providing a substrate; depositing phosphor powder layer on the substrate; and coating the phosphor layer with a layer of thermal and electrically-conductive luminescent material by atomic layer deposition (ALD).

9. The method of embodiment 8, wherein the phosphor comprises a sedimentary phosphor layer prior to coating with the layer of thermal and electrically-conductive luminescent material.

10. The method of embodiment 8, wherein the substrate is selected from the group of media consisting of glass, quartz, fused silica, borosilicate, and other transparent media.

11. The method of embodiment 8, wherein the phosphor is selected from the group of phosphors consisting of Y₂O₃:Eu, Y₂O₂S:Eu, or any cathodoluminescent (CL) phosphors or photoluminescent (PL) phosphor.

12. The method of embodiment 8, wherein the layer of thermal and electrically-conductive luminescent material comprises a thin film that conforms to the morphology of the phosphor powder layer.

13. The method of embodiment 8, wherein the layer of thermal and electrically-conductive luminescent material is deposited using diethyl Zinc and H₂O vapor at approximately 150° C.

14. The method of embodiment 8, wherein the layer of thermal and electrically-conductive luminescent material is deposited using a film deposition rate of approximately 2 Å/cycle.

15. The method of embodiment 8, wherein the ALD coating step transfers heat and charge, and simultaneously serves as the binding, thereby eliminating the use of non-luminescent silicate binders.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

We claim:

1. A device construct, comprising:
a substrate;
a phosphor powder layer over the substrate; and
a layer of thermal and electrically-conductive luminescent material over the powder layer.

2. The device construct of claim 1, wherein the phosphor comprises a deposited phosphor layer.

3. The device construct of claim 1, wherein the substrate is selected from the group of media consisting of glass, quartz, fused silica, borosilicate, and other transparent media.

4. The device construct of claim 1, wherein the phosphor is selected from the group of phosphors consisting of Y₂O₃:Eu, Y₂O₂S:Eu, or any cathodoluminescent (CL) phosphors or photoluminescent (PL) phosphors.

5. The device construct of claim 1, wherein the layer of thermal and electrically-conductive luminescent material comprises a thin film that conforms to the morphology of the phosphor powder layer.

6. The device construct of claim 1, wherein the layer of thermal and electrically-conductive luminescent material has a uniform thickness of up to approximately 100 nm.

7. The device construct of claim 1, wherein the device construct is a component of a light emission apparatus.

8. A method of fabricating a device construct, comprising:
providing a substrate;
depositing phosphor powder layer on the substrate; and
coating the phosphor layer with a layer of thermal and electrically-conductive luminescent material by atomic layer deposition (ALD).

9. The method of claim 8, wherein the phosphor comprises a sedimentary phosphor layer prior to coating with the layer of thermal and electrically-conductive luminescent material.

10. The method of claim 8, wherein the substrate is selected from the group of media consisting of glass, quartz, fused silica, borosilicate, and other transparent media.

11. The method of claim 8, wherein the phosphor is selected from the group of phosphors consisting of Y₂O₃:Eu, Y₂O₂S:Eu, or any cathodoluminescent (CL) phosphors or photoluminescent (PL) phosphor.

12. The method of claim 8, wherein the layer of thermal and electrically-conductive luminescent material comprises a thin film that conforms to the morphology of the phosphor powder layer.

13. The method of claim 8, wherein the layer of thermal and electrically-conductive luminescent material is deposited using diethyl Zinc and H₂O vapor at approximately 150° C.

14. The method of claim 8, wherein the layer of thermal and electrically-conductive luminescent material is deposited using a film deposition rate of approximately 2 Å/cycle.

15. The method of claim 8, wherein the ALD coating step transfers heat and charge, and simultaneously serves as the binding, thereby eliminating the use of non-luminescent silicate binders.
